(19) United States
(12) Patent Application Publication
(10) Pub. No.: US 2024/0136086 A1
(43) Pub. Date: Apr. 25, 2024

(54) WIRING MODULE AND ELASTIC WATER-STOP MEMBER

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Mie (JP)

(72) Inventors: Hirokazu KOMORI, Osaka (JP); Tsubasa MARUYAMA, Osaka (JP)

(21) Appl. No.: 18/269,184

(22) PCT Filed: Dec. 7, 2021
(86) PCT No.: PCT/JP2021/044936

§ 371 Date: Jun. 21, 2023

(30) Foreign Application Priority Data
Dec. 23, 2020 (JP) 2020-214033

(51) Int. Cl. H01B 7/282

(52) U.S. Cl. CPC H01B 7/282

(57) ABSTRACT

It is aimed to enable more reliable water stopping at a boundary part of an elastic water-stop member. A wiring module is provided with a wiring member including a linear wiring member, and an elastic water-stop member mounted on a part in a longitudinal direction of the wiring member. The elastic water-stop member includes a first divided member and a second divided member. The first divided member is formed with a first partially surrounding portion. The second divided member is formed with a second partially surrounding portion. The first partially surrounding portion is formed with a pair of first reinforcing wall portions and a first lip portion. The second partially surrounding portion is formed with a pair of second reinforcing wall portions and a second lip portion.

### TECHNICAL FIELD

The present disclosure relates to a wiring module and an elastic water-stop member.

### BACKGROUND

Patent Document 1 discloses a sealing structure of a multi-core cable provided with a rubber plug. The rubber plug is formed with through holes. Wires are sealed by being passed through the through holes.

### PRIOR ART DOCUMENT

### Patent Document

Patent Document 1: JP 2016-010303 A

### SUMMARY OF THE INVENTION

### Problems to be Solved

To facilitate the arrangement of the wires in the through holes, a divided structure of the rubber plug is considered.

In this case, more reliable water stopping is required at a boundary part of the rubber plug.

Accordingly, the present disclosure aims to enable more reliable water stopping at a boundary part of an elastic water-stop member when the elastic water-stop member has a divided structure.

### Means to Solve the Problem

The present disclosure is directed to a wiring module with a wiring member including at least one linear wiring member, and an elastic water-stop member mounted on a part in a longitudinal direction of the wiring member, the elastic water-stop member including a first divided member and a second divided member, the first divided member being formed with a first partially surrounding portion constituting a part of a hole capable of accommodating the part in the longitudinal direction of the wiring member, the second divided member being formed with a second partially surrounding portion constituting another part of the hole capable of accommodating the part in the longitudinal direction of the wiring member, a pair of first reinforcing wall portions being formed on both sides in a circumferential direction of the first partially surrounding portion, a first lip portion being formed between the pair of first reinforcing wall portions, a pair of second reinforcing wall portions being formed on both sides in a circumferential direction of the second partially surrounding portion, a second lip portion being formed between the pair of second reinforcing wall portions, and the pair of first reinforcing wall portions and the pair of second reinforcing wall portions being butted against each other and at least a part of the wiring member being arranged in the hole constituted by the first and second partially surrounding portions with the first and second divided members united.

The present disclosure is also directed to an elastic water-stop member to be mounted on a part in a longitudinal direction of a wiring member including at least one linear wiring member, the elastic water-stop member being provided with a first divided member and a second divided member, the first divided member being formed with a first partially surrounding portion constituting a part of a hole capable of accommodating the part in the longitudinal direction of the wiring member, the second divided member being formed with a second partially surrounding portion constituting another part of the hole capable of accommodating the part in the longitudinal direction of the wiring member, a pair of first reinforcing wall portions being formed on both sides in a circumferential direction of the first partially surrounding portion, a first lip portion being formed between the pair of first reinforcing wall portions, a pair of second reinforcing wall portions being formed on both sides in a circumferential direction of the second partially surrounding portion, a second lip portion being formed between the pair of second reinforcing wall portions, and the pair of first reinforcing wall portions and the pair of second reinforcing wall portions being butted against each other and the hole capable of arranging at least a part of the wiring member therein being formed by the first and second partially surrounding portions with the first and second divided members united.

### Effect of the Invention

According to the present disclosure, more reliable water stopping can be achieved at a boundary part of an elastic water-stop member when the elastic water-stop member has a divided structure.

### BRIEF DESCRIPTION OF THE DRAWINGS

FIG. 1 is a perspective view showing a wiring module according to an embodiment.

FIG. 2 is an exploded perspective view showing the wiring module.

FIG. 3 is an exploded perspective view showing the wiring module.

FIG. 4 is an exploded perspective view showing an elastic water-stop member.

FIG. 5 is a front view showing the elastic water-stop member.

FIG. 6 is an enlarged perspective view showing first partial surrounding portions and a second divided member.

FIG. 7 is an enlarged perspective view showing the first partial surrounding portion and the second divided member.

FIG. 8 is a diagram showing a comparative example.

FIG. 9 is a diagram showing a positional relationship of reinforcing wall portions and lip portions.

FIG. 10 is a back view of the elastic water-stop member.

FIG. 11 is a front view showing an arrangement example of linear wiring members with respect to the elastic water-stop member.

FIG. 12 is a front view showing an elastic water-stop member according to a modification.

FIG. 13 is a front view showing an elastic water-stop member according to another modification.

### DETAILED DESCRIPTION TO EXECUTE THE INVENTION

### Description of Embodiments of Present Disclosure

First, embodiments of the present disclosure are listed and described.

The wiring module of the present disclosure is as follows.
(1) The wiring module is provided with a wiring member including at least one linear wiring member, and an elastic water-stop member mounted on a part in a longitudinal direction of the wiring member, the elastic water-stop member including a first divided member and a second divided member, the first divided member being formed with a first partially surrounding portion constituting a part of a hole capable of accommodating the part in the longitudinal direction of the wiring member, the second divided member being formed with a second partially surrounding portion constituting another part of the hole capable of accommodating the part in the longitudinal direction of the wiring member, a pair of first reinforcing wall portions being formed on both sides in a circumferential direction of the first partially surrounding portion, a first lip portion being formed between the pair of first reinforcing wall portions, a pair of second reinforcing wall portions being formed on both sides in a circumferential direction of the second partially surrounding portion, a second lip portion being formed between the pair of second reinforcing wall portions, and the pair of first reinforcing wall portions and the pair of second reinforcing wall portions being butted against each other and at least a part of the wiring member being arranged in the hole constituted by the first and second partially surrounding portions with the first and second divided members united.

According to this wiring module, the first and second lip portions are pressed against the wiring member by uniting the first and second divided members, whereby the wiring member is pressed against the pair of first reinforcing wall portions and the pair of second reinforcing wall portions. Further, since the pair of first reinforcing wall portions and the pair of second reinforcing wall portions are butted against each other, gaps are hardly formed between the first and second divided members. Thus, water stopping utilizing elasticity can be achieved around the wiring member entirely in the circumferential direction and, when the elastic water-stop member has a divided structure, more reliable water stopping can be achieved in a boundary part of the elastic water-stop member.
(2) In the wiring module of (1), inner peripheral parts of the pair of first reinforcing wall portions, the first lip portion, the pair of second reinforcing wall portions and the second lip portion may be connected to form a circle as a whole with the first and second divided members united. In this way, the inner peripheral part of each of the pair of first reinforcing wall portions, the first lip portion, the pair of second reinforcing wall portions and the second lip portion is easily held in close contact with the outer periphery of the wiring member.
(3) In the wiring module of (2), a diameter of the circle formed by connecting the inner peripheral parts of the pair of first reinforcing wall portions, the first lip portion, the pair of second reinforcing wall portions and the second lip portions may be smaller than a diameter of the part of the wiring member to be arranged in the hole. In this case, the first and second lip portions are pushed radially outward and effectively compressed by arranging a part of the wiring member in the hole. In this way, the pair of first reinforcing wall portions and the pair of second reinforcing wall portions are pushed outward and pressed against each other.
(4) In the wiring module of any one of (1) to (3), a plurality of the first lip portions may be formed side by side at intervals in the longitudinal direction of the wiring member, the pair of first reinforcing wall portions may extend to connect the plurality of first lip portions, a plurality of the second lip portions may be formed side by side at intervals in the longitudinal direction of the wiring member, and the pair of second reinforcing wall portions may extend to connect the plurality of second lip portions. In this way, even if the first and second divided members are displaced and united, water stopping property is easily maintained at a boundary between the first and second divided members.
(5) In the wiring module of any one of (1) to (4), thicknesses of the pair of first reinforcing wall portions in a circumferential direction of the hole may be equal to those of the pair of second reinforcing wall portions. In this way, the first and second reinforcing wall portions can be held in contact in a well-balanced manner with the first and second divided members united.
(6) In the wiring module of any one of (1) to (5), the wiring member may include a plurality of the linear wiring members, the elastic water-stop member may further include a third divided member, and one of the second and third divided members may be formed with the first partially surrounding portion formed with the pair of first reinforcing wall portions and the first lip portion and the other of the second and third divided members may be formed with the second partially surrounding portion formed with the pair of second reinforcing wall portions and the second lip portion in a part where the second and third divided members are facing each other. In this way, at least a part of the wiring member is arranged also between the second and third divided members. Thus, water stopping can be realized for each of the plurality of linear wiring members included in the wiring member.
(7) In the wiring module of any one of (1) to (6), a length of the first partially surrounding portion and that of the second partially surrounding portion in the circumferential direction of the hole may be different. In this way, an operation of uniting the first and second divided members is easily performed with at least a part of the wiring member arranged in the partially surrounding portion having a longer length in the circumferential direction of the hole, out of the first and second partially surrounding portions.
(8) In the wiring module of any one of (1) to (7), an exterior member including a first exterior member and a second exterior member unitable with each other may be further provided, and the elastic water-stop member is accommodated in the exterior member with the first and second exterior members united. In this way, the first and second divided members can be kept in the united state by the first and second exterior members.

Further, the elastic water-stop member of the present disclosure is as follows.
(9) The elastic water-stop member is to be mounted on a part in a longitudinal direction of a wiring member including at least one linear wiring member, and provided with a first divided member and a second divided member, the first divided member being formed with a first partially surrounding portion constituting a part of a hole capable of accommodating the part in the longitudinal direction of the wiring member, the second divided member being formed with a second partially surrounding portion constituting another part of the hole capable of accommodating the part in the longitudinal direction of the wiring member, a pair of first reinforcing wall portions being formed on both sides in a circumferential direction of the first partially surrounding portion, a first lip portion being formed between the pair of first reinforcing wall portions, a pair of second reinforcing wall portions being formed on both sides in a circumferential direction of the second partially surrounding portion, a second lip portion being formed between the pair of second reinforcing wall portions, and the pair of first reinforcing wall portions and the pair of second reinforcing wall portions being butted against each other and the hole capable of arranging at least a part of the wiring member therein being formed by the first and second partially surrounding portions with the first and second divided members united.

According to this elastic water-stop member, the first and second lip portions are pressed against the wiring member by uniting the first and second divided members, whereby the wiring member is pressed against the reinforcing wall portions. Further, since the pair of first reinforcing wall portions and the pair of second reinforcing wall portions are butted against each other, gaps are hardly formed between the first and second divided members. Thus, elastic water stopping can be achieved around the wiring member entirely in the circumferential direction and, when the elastic water-stop member has a divided structure, more reliable water stopping can be achieved in a boundary part of the elastic water-stop member.

### Details of Embodiment of Present Disclosure

Specific examples of a wiring module and an elastic water-stop member of the present disclosure are described below with reference to the drawings. Note that the present disclosure is not limited to these illustrations, but is represented by claims and intended to include all changes in the scope of claims and in the meaning and scope of equivalents.

### Embodiment

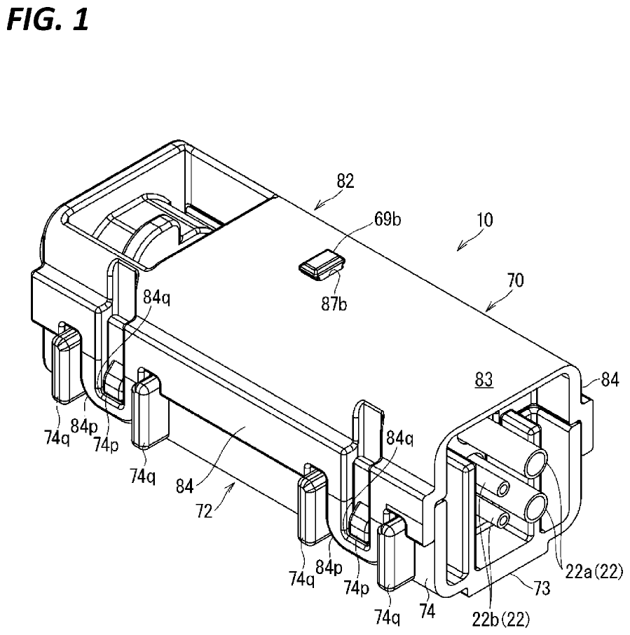

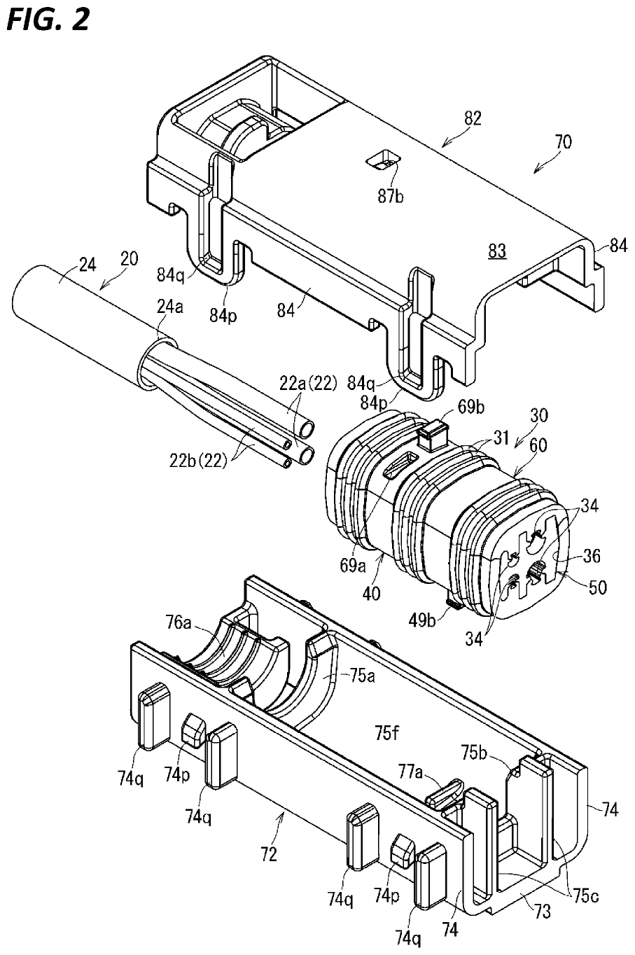

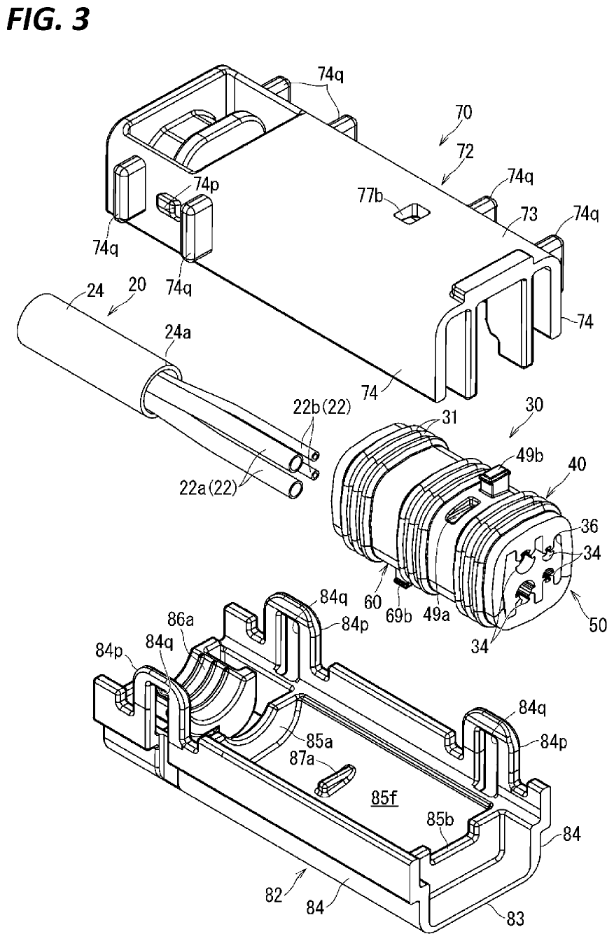

Hereinafter, a wiring module and an elastic water-stop member according to an embodiment are described. FIG. 1 is a perspective view showing a wiring module 10. FIGS. 2 and 3 are exploded perspective views showing the wiring module 10. FIG. 2 is a perspective view from the side of a second exterior member 82, and FIG. 3 is a perspective view from the side of a first exterior member 72. In each figure, a wiring member 20 is partially shown.

The wiring module 10 is provided with the wiring member 20 and an elastic water-stop member 30. In this embodiment, the wiring module 10 is further provided with an exterior member 70. The elastic water-stop member 30 is mounted on a part in a longitudinal direction of the wiring member 20. In this state, the wiring member 20 is passed through the elastic water-stop member 30. Water intrusion along the periphery of the wiring member 20 is suppressed by the elastic water-stop member 30. The elastic water-stop member 30 is accommodated into the exterior member 70. In this way, a state where the wiring member 20 is passed through the elastic water-stop member 30 is maintained.

The configuration of each component is described.

The wiring member 20 includes at least one linear wiring member 22. The wiring member 20 may include only one linear wiring member 22 or may include a plurality of linear wiring members 22. In this embodiment, the wiring member 20 includes a plurality of (four, here) the linear wiring members 22. The linear wiring member 22 is, for example, a coated wire in which a resin coating is formed around a core wire. The linear wiring member may be a cable in which a plurality of wires are covered with a sheath. The linear wiring member may include an electromagnetic shield layer such as a braided wire. The linear wiring member may be a signal wire, a power supply wire or a ground wire.

In this embodiment, the wiring member 20 includes linear wiring members having mutually different thicknesses as the plurality of linear wiring members 22. In the following description, these linear wiring members may be distinguished as thick linear wiring members 22a and thin linear wiring members 22b for the sake of convenience. Here, the wiring member 20 includes two linear wiring members 22a and two linear wiring members 22b.

The wiring member 20 includes a coating member 24 for covering parts in the longitudinal direction of the plurality of linear wiring members 22. The coating member 24 is, for example, a sheath formed, such as by extruding softened and melted resin to cover around the linear wiring members 22. The coating member 24 may be an adhesive tape spirally wound around the linear wiring members 22. The coating member 24 may also be a corrugated tube, a resin tube, a resin sheet or the like externally mounted on the linear wiring members 22. Parts of the plurality of linear wiring members 22 covered by the coating member 24 are kept bundled by the coating member 24. Parts of the plurality of linear wiring members 22 coming out from the coating member 24 may be branched into a plurality of parts.

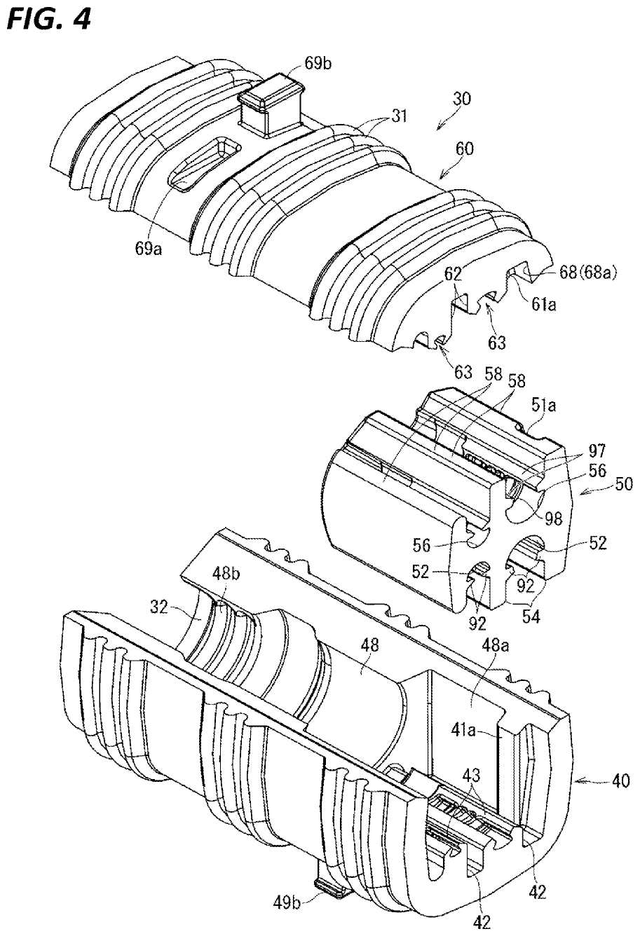

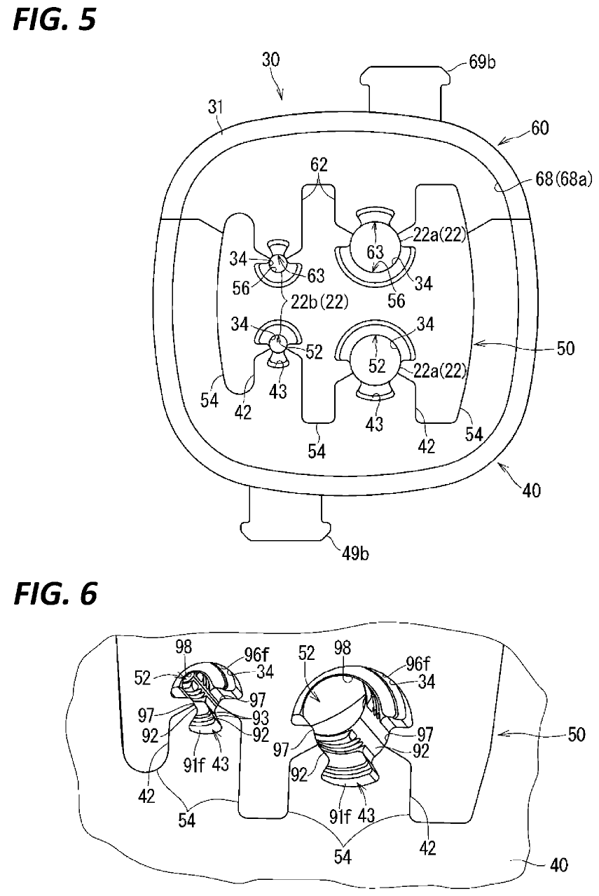

FIG. 4 is an exploded perspective view showing the elastic water-stop member 30. FIG. 5 is a front view showing the elastic water-stop member 30. The overall configuration of the elastic water-stop member 30 is described. As shown in FIGS. 1 to 5, the elastic water-stop member 30 is formed of an elastic material such as silicone rubber. In this embodiment, the elastic water-stop member 30 is formed into a rectangular column shape with rounded corners. Besides, the elastic water-stop member may be formed into a cylindrical shape or the like.

Annular protrusions 31 are formed on the outer periphery of the elastic water-stop member 30. With the elastic water-stop member 30 accommodated in the exterior member 70, the annular protrusions 31 are in contact with the inner peripheral surface of the exterior member 70 while being elastically deformed. In this way, the elastic water-stop member 30 can be accommodated into the exterior member 70 while being compressively deformed mainly at the annular protrusions 31.

Out of the wiring member 20, an end part 24a of the coating member 24 and parts of the linear wiring members 22 extending from the end part 24a of the coating member 24 are accommodated in the elastic water-stop member 30. Thus, a coating member arrangement hole 32 for accommodating the end part of the coating member 24 is formed in one end part of the elastic water-stop member 30. Further, linear wiring member arrangement holes 34 capable of accommodating the linear wiring members 22 are formed in the other end part of the elastic water-stop member 30. In this embodiment, a plurality of the linear wiring member arrangement holes 34 are formed in the other end part of the elastic water-stop member 30. In the elastic water-stop member 30, the plurality of linear wiring member arrangement holes 34 are connected to the common coating member arrangement hole 32. Thus, the plurality of linear wiring members 22 extending from the coating member 24 arranged in the coating member arrangement hole 32 can be separately arranged in the plurality of linear wiring member arrangement holes 34. Note that the plurality of linear wiring member arrangement holes 34 have different inner diameters to correspond to the linear wiring members 22a, 22b having different thicknesses.

The elastic water-stop member 30 includes a first divided member 40 and a second divided member 50. In this embodiment, the elastic water-stop member 30 further includes a third divided member 60. The first, second and third divided members 40, 50 and 60 are members obtained by dividing the elastic water-stop member 30. Planes dividing these may be parallel to the linear wiring members 22. Based on a united structure of the second and third divided members 50, 60, the third divided member 60 may be grasped as a first divided member and the second divided member 50 may be grasped as a second divided member to be united with the third divided member 60 serving as the first divided member.

The first and third divided members 40, 60 are formed into shapes obtained by dividing an outer peripheral part of the elastic water-stop member 30 into two. In this embodiment, the first divided member 40 is formed to have a larger shape than the third divided member 60. The first and third divided members 40, 60 may be shaped by equally dividing the outer peripheral part of the elastic water-stop member 30 into two.

Out of the first divided member 40, a part facing the third divided member 60 is formed with an accommodation recess 48. The accommodation recess 48 is in the form of a groove open on both end sides of the first divided member 40. A part near one end of the first divided member 40, out of the accommodation recess 48, is formed into a coating accommodation recess 48b for accommodating the coating member 24. A part near the other end of the first divided member 40, out of the accommodation recess 48, is formed into an intermediate divided member accommodating portion 48a capable of accommodating the second divided member 50.

Out of the third divided member 60, a part facing the first divided member 40 is formed with an accommodation recess 68. The accommodation recess 68 is in the form of a groove open on both end sides of the third divided member 60. The accommodation recess 68 is shallower than the accommodation recess 48. A part near one end of the third divided member 60, out of the accommodation recess 68, is formed into a coating accommodation recess for accommodating the coating member 24. With the first and third divided members 40, 60 united, the coating member arrangement hole 32 in the form of a circular hole and capable of accommodating the end part of the coating member 24 is formed by the coating accommodation recess 48b and the coating accommodation recess. A part near the other end of the third divided member 60, out of the accommodation recess 68, is formed into an intermediate divided member accommodating portion 68a capable of accommodating the second divided member 50. With the first and third divided members 40, 60 united, an intermediate divided member accommodation hole 36 capable of accommodating the second divided member 50 is formed by the intermediate divided member accommodating portion 48a and the intermediate divided member accommodating portion 68a. The intermediate divided member accommodation hole 36 is formed on an extension of the coating member arrangement hole 32.

With the second divided member 50 partially accommodated in the intermediate divided member accommodating portion 48a of the first divided member 40, the third divided member 60 is put on the first divided member 40 to close an opening of the accommodation recess 48 in the first divided member 40. In this state, a part protruding from the intermediate divided member accommodating portion 48a, out of the second divided member 50, is accommodated in the intermediate divided member accommodating portion 68a in the third divided member 60. In this way, the first, second and third divided members 40, 50 and 60 are united.

Further, one of the first and second divided members 40, 50 is formed with a divided member erroneous assembly preventing protrusion 41a, and the other is formed with a divided member erroneous assembly preventing recess 51a. Here, the divided member erroneous assembly preventing recess 51a is formed at a position near an outer end part in one side part of the second divided member 50. The divided member erroneous assembly preventing recess 51a is in the form of a groove extending from the side of the first divided member 40 toward the side of the third divided member 60. Further, the divided member erroneous assembly preventing protrusion 41a having an elongated convex shape extending from the bottom toward an end part of the intermediate divided member accommodating portion 48a is formed at a position corresponding to the divided member erroneous assembly preventing recess 51a on one of inner side surfaces of the intermediate divided member accommodating portion 48a in the first divided member 40. Note that, in this embodiment, a divided member erroneous assembly preventing protrusion 61a having an elongated convex shape extending from the bottom toward an end part of the intermediate divided member accommodating portion 68a is formed at a position corresponding to the divided member erroneous assembly preventing recess 51a on one of inner side surfaces of the intermediate divided member accommodating portion 68a in the third divided member 60. The divided member erroneous assembly preventing protrusion 61a is formed on an extension of the divided member erroneous assembly preventing protrusion 41a.

In a posture in which the divided member erroneous assembly preventing protrusion 41a is arranged in the divided member erroneous assembly preventing recess 51a, the second divided member 50 can be arranged in the intermediate divided member accommodating portion 48a in the first divided member 40. In other postures, the divided member erroneous assembly preventing protrusion 41a interferes with the outer side surface of the second divided member 50 and it becomes difficult to arrange the second divided member 50 in the intermediate divided member accommodating portion 48a in the first divided member 40. Similarly, in a posture in which the divided member erroneous assembly preventing protrusion 61a is arranged in the divided member erroneous assembly preventing recess 51a, the third divided member 60 can be united on the second divided member 50 united with the first divided member 40. In other postures, the divided member erroneous assembly preventing protrusion 61a interferes with the outer side surface of the second divided member 50 and it becomes difficult to unite the third divided member 60 on the second divided member 50 united with the first divided member 40.

First partially surrounding portions 43 are formed in a part of the first divided member 40 facing the second divided member 50. Second partially surrounding portions 52 are formed in a part of the second divided member 50 facing the first divided member 40. The first partially surrounding portion 43 is a part constituting a circumferential part of the linear wiring member arrangement hole 34. The second partially surrounding portion 52 is a part constituting another circumferential part of the linear wiring member arrangement hole 34. The linear wiring member arrangement hole 34 is formed by connecting the first and second partially surrounding portions 43, 52 into an annular shape.

In this embodiment, the second partially surrounding portion 52 is in the form of a groove open on both end sides. One side of the second partially surrounding portion 52 is open inside the elastic water-stop member 30, and the other end side of the second partially surrounding portion 52 is open to the outside of the elastic water-stop member 30. A side of the second partially surrounding portion 52 opposite to a bottom part is formed into an elongated opening shape. That elongated opening is formed into a slit connecting openings on both end sides of the second partially surrounding portion 52.

A depth of the second partially surrounding portion 52 is preferably larger than a diameter of the linear wiring member 22 to be arranged in the second partially surrounding portion 52. Further, the second partially surrounding portion 52 preferably has a shape larger than half the circular cross-section of the linear wiring member 22 to be arranged in the second partially surrounding portion 52. Further, an opening width of the elongated opening of the second partially surrounding portion 52 is preferably smaller than a diameter of the linear wiring member 22 to be arranged in the second partially surrounding portion 52.

A pair of guiding wall portions 54 project outward from both side edges of the elongated opening of the second partially surrounding portion 52. The pair of guiding wall portions 54 project in parallel from the both side edges of the elongated opening toward a side opposite to the bottom of the second partially surrounding portion 52 while being spaced apart. In this embodiment, two second partially surrounding portions 52 are formed in parallel and each of these is formed with the pair of guiding wall portions 54. An interval between the pair of guiding wall portions 54 on the side of the second partially surrounding portion 52 for the thick linear wiring member 22a is larger than that between the pair of guiding wall portions 54 on the side of the second partially surrounding portion 52 for the thin linear wiring member 22b. The guiding wall portion 54 between the two second partially surrounding portions 52 is the guiding wall portion 54 common to the two second partially surrounding portions 52.

A gap equal to or more than the diameter of the linear wiring member 22 is preferably formed between the pair of guiding wall portions 54. Heights of the pair of guiding wall portions 54 are preferably equal to or more than the radius of the linear wiring member 22 and more preferably equal to or more than the diameter of the linear wiring member 22. The height of the guiding wall portion 54 may be a height from an outer edge part of the elongated opening.

The pair of guiding wall portions 54 preferably have guide surfaces, the spacing between which is gradually narrowed toward the elongated opening. In this example, parts on the side of the elongated opening, out of the pair of guiding wall portions 54, are formed into the guide surfaces extending toward a center between the pair of guiding wall portions 54 as extending toward the elongated opening. Parts opposite to the elongated opening, out of the pair of guiding wall portions 54, are formed into restricting surfaces extending in directions parallel to each other. Thus, the linear wiring member 22 pushed into between the pair of guiding wall portions 54 moves toward the second partially surrounding portion 52 while being guided by the restricting surfaces and is guided toward the elongated opening in the center between the pair of guiding wall portions 54 by being guided by the pair of guide surfaces on the back sides of the pair of guiding wall portions 54. Then, the linear wiring member 22 can be pushed into the second partially surrounding portion 52 through the elongated opening.

The first partially surrounding portions 43 on the side of the first divided member 30 are formed on tip parts of convex lid portions 42 formed in the first divided member 40. The convex lid portion 42 is a part for closing the elongated opening on the side of the second partially surrounding portion 52 by being arranged between the pair of guiding wall portions 54 with the first and second divided members 40, 50 united. More specifically, two convex lid portions 42 are formed side by side in a bottom part of the intermediate divided member accommodating portion 48a. Each of the two convex lid portions 42 is formed into a shape corresponding to the inner surfaces of the pair of guiding wall portions 54. That is, both side surfaces of the base end of the convex lid portion 42 are formed into surfaces extending in parallel to correspond to the pair of restricting surfaces. Both side surfaces of the tip part of the convex lid portion 42 are formed into surfaces inclined to gradually narrow the spacing therebetween toward a tip side to correspond to the pair of guide surfaces. Thus, the convex lid portion 42 can be accommodated between the pair of guiding wall portions 54 with gaps between the convex lid portion 42 and the inner surfaces of the pair of guiding wall portions 54 eliminated.

Further, the first partially surrounding portion 43 is formed on the tip part of the convex lid portion 42. With the convex lid portion 42 accommodated between the pair of guiding wall portions 54, the first and second partially surrounding portions 43, 52 are connected into an annular shape, thereby forming the linear wiring member arrangement hole 34. Lengths of the first and second partially surrounding portions 43, 52 are different in a circumferential direction of the linear wiring member arrangement hole 34. Here, the second partially surrounding portion 52 is longer than the first partially surrounding portion 43 and constitutes more than a semicircle.

The first partially surrounding portion 43 is formed with a pair of first reinforcing wall portions 92 and first lip portions 93. The second partially surrounding portion 52 is formed with a pair of second reinforcing wall portions 97 and second lip portions 98. The configurations of these are described in more detail later.

In this embodiment, a part of the second divided member 50 facing the third divided member 60 is formed with second partially surrounding portions 56 and pairs of guiding wall portions 58. The second partially surrounding portion 56 is a part similar to the second partially surrounding portion 52, and the pair of guiding wall portions 58 are parts similar to the pair of guiding wall portions 54. The second divided member 50 may be symmetrically shaped with respect to a plane passing through a center between the second partially surrounding portions 52 and the second partially surrounding portions 56.

Further, a part of the third divided member 60 facing the second divided member 50 is formed with first partially surrounding portions 63. Here, the third divided member 60 is formed with a pair of convex lid portions 62 similar to the first partially surrounding portions 43 in the first divided member 40, and the first partially surrounding portions 63 are formed on tip parts of the pair of convex lid portions 62. The first partially surrounding portion 63 is a part similar to the first partially surrounding portion 43 described above.

The first partially surrounding portion 63 is also formed with a pair of reinforcing wall portions 102 and first lip portions 103. The second partially surrounding portion 56 is also formed with a pair of second reinforcing wall portions 107 and second lip portions 108.

With the second and third divided members 50, 60 united, the convex lid portions 62 are arranged between the pairs of guiding wall portions 58, whereby the tip parts of the convex lid portions 62 are arranged in elongated openings of the second partially surrounding portions 56. In this state, the first partially surrounding portion 63 on the tip part of the convex lid portion 62 and the second partially surrounding portion 56 are connected into an annular shape. In this way, the linear wiring member arrangement hole 34 constituted by the first and second partially surrounding portions 63, 56 is formed with the second and third divided members 50, 60 united.

Thus, in this embodiment, the second partially surrounding portions 52 and the pairs of guiding wall portions 54 are formed in the part of the second divided member 50 facing the first divided member 40, and the second partially surrounding portions 56 and the pairs of guiding wall portions 58 are formed in the part of the second divided member 50 facing the third divided member 60. Further, each of the first and third divided members 40, 60 is formed with the first partially surrounding portions 43, 63.

The exterior member 70 is a member for accommodating the elastic water-stop member 30, particularly a member for covering the outer periphery of the elastic water-stop member 30 with the first, second and third divided members 40, 50 and 60 kept united. The exterior member 70 is provided with the first exterior member 72 and the second exterior member 82 unitable with each other. The elastic water-stop member 30 is accommodated in the exterior member 70 with the first and second exterior members 72, 82 united.

More specifically, each of the first and second exterior members 72, 82 is a member formed of resin or the like.

The first exterior member 72 includes a bottom plate portion 73 and a pair of side wall portions 74. The bottom plate portion 73 is in the form of a rectangular plate. The pair of side wall portions 74 stand on both sides of the bottom plate portion 73. Uniting protrusions 74p are formed on the outer surfaces of the side wall portions 74. The uniting protrusion 74p is formed into a shape having a projecting dimension gradually reduced toward a tip side of the side wall portion 74. Guide protrusions 74q are formed on both outer sides of the uniting protrusion 74p. The guide protrusion 74q is formed into an elongated protrusion shape extending from a base end side toward the tip side of the side wall portion 74.

A water-stop member divided holding surface 75f corresponding to a part of the outer peripheral surface shape of the elastic water-stop member 30 is formed in a longitudinal intermediate part of the bottom plate portion 73. A part of the elastic water-stop member 30, particularly an outer peripheral surface part of the first divided member 40, is accommodated on the water-stop member divided holding surface 75f.

A first positioning portion 75a is provided on one end part of the water-stop member divided holding surface 75f. The first positioning portion 75a is formed into a U shape projecting further inward than the inner peripheral surface of the water-stop member divided holding surface 75f. A recess capable of arranging the coating member 24 therein is formed in the first positioning portion 75a. A semi-tubular holding portion 76a capable of accommodating the coating member 24 is formed on the one end part of the bottom plate portion 73. The semi-tubular holding portion 76a is located on the outer side of the first positioning portion 75a. Protrusions along a circumferential direction are formed on the inner peripheral surface of the semi-tubular holding portion 76a. A part of the coating member 24 of the wiring member 20 extending from the elastic water-stop member 30 is held in the semi-tubular holding portion 76a through the first positioning portion 75a.

A second positioning portion 75b is provided on the other end part of the water-stop member divided holding surface 75f. The second positioning portion 75b is formed into a U shape projecting further inward than the inner peripheral surface of the water-stop member divided holding surface 75f. A pair of restricting wall portions 75c are provided side by side on the outer side of the second positioning portion 75b while being spaced apart. The linear wiring members 22 extending from the elastic water-stop member 30 extend outward through a recess in the second positioning portion 75b and between the pair of restricting wall portions 75c.

A positioning protrusion 77a is formed on one side of a part near the second positioning portion 75b, out of the water-stop member divided holding surface 75f, and a positioning recess 77b is formed adjacent to the positioning protrusion 77a. The positioning protrusion 77a projects from the water-stop member divided holding surface 75f, and the positioning recess 77b is recessed from the water-stop member divided holding surface 75f.

A water-stop member side positioning recess 49a, into which the positioning protrusion 77a is fittable, is formed at a position corresponding to the positioning protrusion 77a on the outer peripheral surface of the first divided member 40, out of the elastic water-stop member 30, and a water-stop member side positioning protrusion 49b fittable into the positioning recess 77b is formed adjacent to the water-stop member side positioning recess 49a. If the elastic water-stop member 30 is arranged on the water-stop member divided holding surface 75f in such a posture that the linear wiring member arrangement holes 34 of the elastic water-stop member 30 are facing toward the second positioning portion 75b, the positioning protrusion 77a can be fit into the water-stop member positioning recess 49a and, at the same time, the water-stop member side positioning protrusion 49b can be fit into the positioning recess 77b. If an attempt is made to set the first divided member 40 in the first exterior member 72 in a posture different from the above one, the positioning protrusion 77a interferes with the outer surface of the first divided member 40 and the water-stop member side positioning protrusion 49b interferes with the water-stop member divided holding surface 75f. The first divided member 40 can be set in a correct posture in the first exterior member 72 based on whether the above interference is present or not.

The positioning protrusion 77a and the water-stop member side positioning recess 49a are examples of an erroneous assembly preventing protrusion and an erroneous assembly preventing recess, and the water-stop member side positioning protrusion 49a and the positioning recess 77b are also examples of the erroneous assembly preventing protrusion and the erroneous assembly preventing recess. Either one or both of these may be omitted.

The first divided member 40 is set on the water-stop member divided holding surface 75f with the water-stop member side positioning protrusion 49b fit in the positioning recess 77b and the positioning protrusion 77a fit in the water-stop member side positioning recess 49a. In this state, one end surface of the first divided member 40 is in contact with the first positioning portion 75a and the other end surface thereof is in contact with the second positioning portion 75b. In this way, the first divided member 40 is positioned in an axial direction thereof with respect to the first exterior member 72. In this state, the accommodation recess 48 of the first divided member 40 is open toward a side opposite to the water-stop member divided holding surface 75f. Thus, a mounting operation of the second divided member 50 into the accommodation recess 48 and the like can be performed with the first divided member 40 set in the first exterior member 72.

The second exterior member 82 includes a ceiling plate portion 83 and a pair of side wall portions 84. The ceiling plate portion 83 is in the form of a rectangular plate, similarly to the bottom plate portion 73. The pair of side wall portions 84 project from both sides of the ceiling plate portion 83. Uniting recesses 84q are formed in the outer surfaces of the side wall portions 84. Here, uniting extending pieces 84p are formed to extend from the outer surfaces of the side wall portions 84 toward tip sides thereof. A uniting recess, in which the uniting protrusion 74p can be arranged, is formed in a tip part of the uniting extending piece 84p. With the second exterior member 82 stacked on the first exterior member 72, the tip edges of the pair of side wall portions 74 and those of the pair of side wall portions 84 are arranged opposite to each other. Note that overlapping pieces of the tip parts of the pair of side wall portions 84 cover the outer sides of the tip edges of the pair of side wall portions 74. In this state, tip parts of the uniting extending pieces 84p ride over the uniting protrusions 74p and the uniting protrusions 74p enter the uniting recesses. In this way, the uniting protrusions 74p are hooked and retained in the uniting recesses 84q, and a united state of the first and second exterior members 72, 82 is maintained.

A water-stop member divided holding surface 85f in the form of a semi-circumferential surface is formed in a longitudinal intermediate part of the ceiling plate portion 83. A part of the outer periphery of the elastic water-stop member 30, particularly an outer peripheral part of the third divided member 60, is accommodated on the water-stop member divided holding surface 85f. The elastic water-stop member 30 is accommodated into a space formed by the water-stop member divided holding surfaces 75f and 85f.

A first positioning portion 85a is provided on one end part of the water-stop member divided holding surface 85f. The first positioning portion 85a is formed into an arc shape projecting further inward than the inner peripheral surface of the water-stop member divided holding surface 85f. The first positioning portion 85a positions the elastic water-stop member 30 by contacting one end surface of the third divided member 60. A semi-tubular holding portion 86a configured similarly to the semi-tubular holding portion 76a is formed on one end part of the ceiling plate portion 83. With the first and second exterior members 72, 82 united, the semi-tubular holding portions 76a, 86a sandwich and hold the coating member 24.

A second positioning portion 85b is provided on the other end part of the water-stop member divided holding surface 85f. The second positioning portion 75b is formed with a shallow recess. With the first and second exterior members 72, 82 united, the second positioning portion 85b positions the third divided member 60 by contacting the other end surface of the third divided member 60.

A positioning protrusion 87a and a positioning recess 87b are formed on and in the water-stop member divided holding surface 85f of the ceiling plate portion 83. The positioning protrusion 87a is configured similarly to the positioning protrusion 77a, and the positioning recess 87b is formed similarly to the positioning recess 77b. The positioning protrusion 87a and the positioning recess 87b are different from the positioning protrusion 77a and the positioning recess 77b in formation positions with respect to the elastic water-stop member 30. That is, the positioning protrusion 87a and the positioning recess 87b are formed near the coating member arrangement hole 32, out of the water-stop member divided holding surface 85f. Further, in a width direction of the water-stop member divided holding surface 85f, a positional relationship of the positioning protrusion 87a and the positioning recess 87b is laterally opposite to that of the positioning protrusion 77a and the positioning recess 77b. A water-stop member side positioning recess 69a, into which the positioning protrusion 87a is fittable, is formed at a position corresponding to the positioning protrusion 87a in the outer peripheral surface of the elastic water-stop member 30 on the side of the third divided member 60, and a water-stop member side positioning protrusion 69b fittable into the positioning recess 87b is formed adjacent to the water-stop member side positioning recess 69a.

Thus, if the posture of the third divided member 60 is opposite to the proper one, the positioning protrusion 87a interferes with the outer surface of the third divided member 60 and the water-stop member side positioning protrusion 69a interferes with the water-stop member divided holding surface 85f. The third divided member 60 and the second exterior member 82 can be set in a correct positional relationship based on whether the above interference is present or not.

The positioning protrusion 87a and the water-stop member side positioning recess 69a are examples of the erroneous assembly preventing protrusion and the erroneous assembly preventing recess, and the water-stop member side positioning protrusion 69a and the positioning recess 87b are also examples of the erroneous assembly preventing protrusion and the erroneous assembly preventing recess. Either one or both of these may be omitted.

Further, also when the first and third divided members 40, 60 are in incorrect positions, interference such as that of the positioning protrusion 77a with the outer surface of the third divided member 60 or that of the positioning protrusion 87a with the outer surface of the first divided member 40 possibly occurs. Thus, it is possibly suppressed that the first and third divided members 40, 60 are erroneously set in the first and second exterior members 72, 82.

With the third divided member 60 set in the second exterior member 82, the outer peripheral surface of the third divided member 60 is accommodated on the water-stop member divided holding surface 85f. In this state, the one end surface of the third divided member 60 is in contact with the first positioning portion 85a. Further, the other end surface of the third divided member 60 is in contact with the second positioning portion 85b. In this way, the third divided member 60 is positioned in an axial direction thereof with respect to the second exterior member 82. Since the accommodation recess 68 of the third divided member 60 is open toward a side opposite to the water-stop member divided holding surface 85f, an upper part of the second divided member 50 united with the first divided member 40 can be fit into the accommodation recess 68 in assembling the second exterior member 82 with the first exterior member 72.

The pairs of first reinforcing wall portions 92 and the first lip portions 93 formed in the first partially surrounding portions 43, 63 and the pairs of second reinforcing wall portions 97 and the second lip portions 98 formed in the second partially surrounding portions 52, 56 are more specifically described.

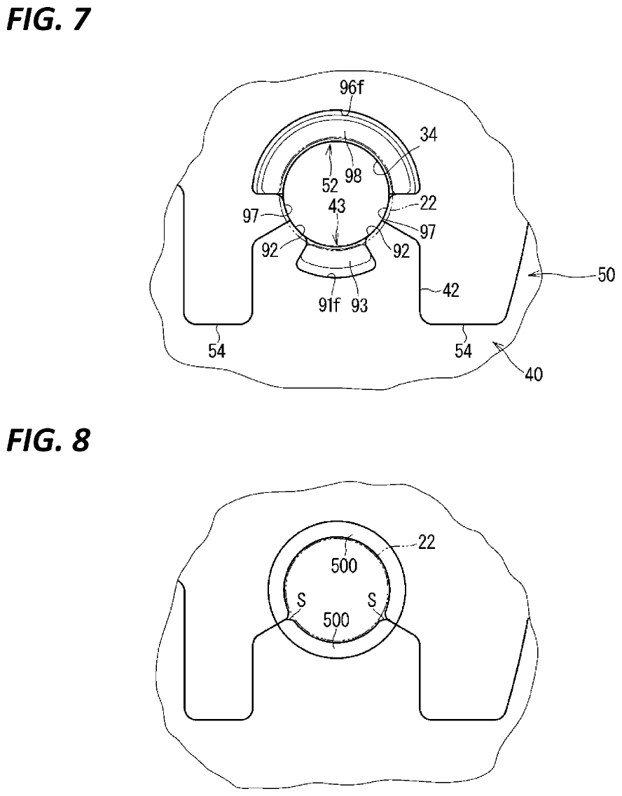

FIG. 6 is an enlarged perspective view showing the first partially surrounding portions 43 and the second partially surrounding portions 52. FIG. 7 is an enlarged front view showing the first partially surrounding portion 43 and the second partially surrounding portion 52. The second partially surrounding portion 52 has a partial circumferential surface 91f in the circumferential direction. The first partially surrounding portion 43 also has a partial circumferential surface 96f in the circumferential direction. The facing circumferential surfaces 91f, 96f are circumferential surfaces having the same radius of curvature, which is larger than the radius of the wire 22 to be arranged.

The pair of first reinforcing wall portions 92 are formed on both sides in the circumferential direction of the first partially surrounding portion 43. The first reinforcing wall portion 92 is a wall projecting toward a center from the circumferential surface 91f. The outward facing surface of the first reinforcing wall portion 92 may be a flat surface along a radial direction of a circle centered on a center of curvature of the circumferential surface 91f. The first reinforcing wall portion 92 may have a higher rigidity than the first lip portion 93. For example, a thickness (thickness in the circumferential direction of the circumferential surface 91f) of the first reinforcing wall portion 92 may be larger than a thickness (in an axial direction of the linear wiring member 22) of the first lip portion 93. The first lip portions 93 are formed between the pair of first reinforcing wall portions 92. The first lip portions 93 are arcuate projection parts extending along the circumferential direction of the circumferential surface 91f.

A plurality of the first lip portions 93 are formed side by side at intervals in a longitudinal direction of the linear wiring member 22. Of course, one first lip portion 93 may be provided. The pair of first reinforcing wall portions 92 extend along both side edge parts of the circumferential surface 91f to connect the plurality of first lip portions 93. Thus, grooves are formed between the plurality of first lip portions 93, but both ends of the grooves are closed by the pair of first reinforcing wall portions 92.

Similarly, a plurality of the second lip portions 98 are formed side by side at intervals in the longitudinal direction of the linear wiring member 22. Of course, one second lip portion 98 may be provided. The pair of second reinforcing wall portions 97 extend along both side edge parts of the circumferential surface 96f to connect the plurality of second lip portions 98. Thus, grooves are formed between the plurality of second lip portions 98, but both ends of the grooves are closed by the pair of second reinforcing wall portions 97.

The pair of second reinforcing wall portions 97 are formed on both sides in the circumferential direction of the second partially surrounding portion 52. The second reinforcing wall portion 97 is a wall projecting toward a center from the circumferential surface 96f. The outward facing surface of the second reinforcing wall portion 97 may be a flat surface along a radial direction of a circle centered on a center of curvature of the circumferential surface 96f. With the first and second divided members 40, 50 united, the outward facing surfaces of the pair of first reinforcing wall portions 92 and those of the second reinforcing wall portions 97 can face each other and be held in surface with each other. The second reinforcing wall portion 97 may have a higher rigidity than the second lip portion 98. For example, a thickness (thickness in the circumferential direction of the circumferential surface 96f) of the second reinforcing wall portion 97 may be larger than a thickness (in the axial direction of the linear wiring member 22) of the second lip portion 98. The second lip portions 98 are formed between the pair of second reinforcing wall portions 97. The second lip portions 98 are arcuate projection parts extending along the circumferential direction of the circumferential surface 96f.

Inward facing parts of the pair of first reinforcing wall portions 92 and those of the first lip portions 93 between the first reinforcing wall portions 92 are continuous along the circumferential direction having the same radius of curvature. Inward facing parts of the pair of second reinforcing wall portions 97 and those of the second lip portions 98 between the second reinforcing wall portions 97 are continuous along the circumferential direction having the same radius of curvature. These radii of curvature are preferably equal. That is, with the first and second divided members 40, 50 united, the pair of first reinforcing wall portions 92, the first lip portions 93, the pair of second reinforcing wall portions 97 and the second lip portions 98 may be connected such that inner peripheral parts thereof form one circle as a whole. A diameter (diameter in a natural state) of this circle is smaller than or equal to the diameter of the linear wiring member 22 to be arranged, preferably smaller than the radius of the linear wiring member 22.

With the first and second divided members 40, 50 united, the convex lid portion 62 is arranged between the pair of guiding wall portions 58 and the pair of first reinforcing wall portions 92 and the pair of second reinforcing wall portions 97 are butted against each other. In this state, a part in the longitudinal direction of the linear wiring member 22 is arranged in the linear wiring member arrangement hole 34 constituted by the first and second partially surrounding portions 43, 52. The first and second partially surrounding portions 43, 52 are continuous via the pair of first reinforcing wall portions 92 and the pair of second reinforcing wall portions 97. Thus, the deformation of the butted parts of the first and second partially surrounding portions 43, 52 is suppressed, and gaps are hardly formed between those.

For example, a configuration is assumed in which the reinforcing wall portions 92, 97 are omitted and lip portions 500 are butted against each other as shown in FIG. 8. In this way, the lip portions 500 themselves are easily deformed by being butted. Thus, there is a possibility that gaps S are formed in butted parts. Particularly, if a radius of curvature of inner peripheral parts of the lip portions 500 is made smaller than the radius of the linear wiring member 22 to press the lip portions 500 against the linear wiring member 22, the lip portions 500 are deformed to be pushed from inside to outside. This may form V-shaped gaps at boundaries between the lip portions 500 due to end edge parts of the lip portions 500 recessed inward.

In contrast, since the deformation of the butted parts of the first and second partially surrounding portions 43, 52 is suppressed by the pair of first reinforcing wall portions 92 and the pair of second reinforcing wall portions 97 in this embodiment, gaps are hardly formed between those partially surrounding portions 43, 52.

Moreover, if the pair of first reinforcing wall portions 92, the first lip portions 93, the pair of second reinforcing wall portions 97 and the second lip portions 98 are connected such that the inner peripheral parts thereof form a circle as a whole, those are easily held in close contact with the linear wiring member 22 entirely in the circumferential direction.

Further, if the diameter of the circle formed by connecting those is smaller than the diameter of the linear wiring member 22, the pair of first reinforcing wall portions 92, the first lip portions 93, the pair of second reinforcing wall portions 97 and the second lip portions 98 are compressed in a radial direction of this circle. If the first lip portions 93 between the pair of first reinforcing wall portions 92 are compressed, the first lip portions 93 are pressed to extend along the circumferential direction of the circumferential surface 91f. In this way, the pair of first reinforcing wall portions 92 are pressed outward in the circumferential direction of the circumferential surface 96f. Similarly, if the second lip portions 98 between the pair of second reinforcing wall portions 97 are compressed, the pair of second reinforcing wall portions 97 are pressed outward in the circumferential direction of the circumferential surface 96f. In this way, the pair of first reinforcing wall portions 92 and the pair of second reinforcing wall portions 97 are pushed in directions to be pressed against each other, and the close contact of the first and second reinforcing wall portions 92, 97 is enhanced.

Thicknesses of the pair of first reinforcing wall portions 92 and those of the pair of second reinforcing wall portions 97 in the circumferential direction of the linear wiring member arrangement hole 34 are preferably equal. Note that thickness identity here includes identity within a manufacturing error range. If these thicknesses are equal, the first and second reinforcing wall portions 92, 97 are hardly deformed toward one side when being pushed in directions approaching each other. Thus, a state where the first and second reinforcing wall portions 92, 97 are in surface contact is easily maintained.

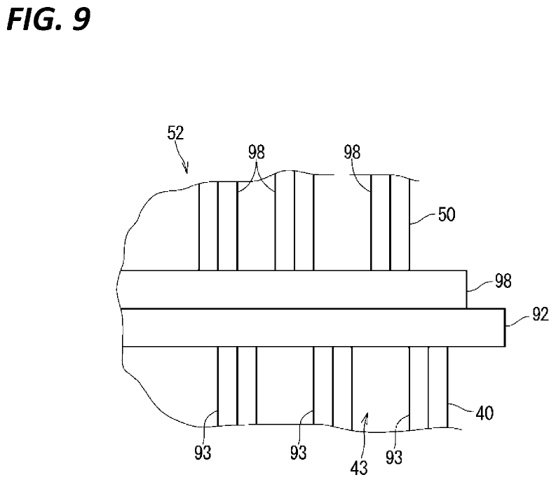

FIG. 9 is a diagram showing a positional relationship of the first reinforcing wall portion 92, the first lip portions 93, the second reinforcing wall portion 97 and the second lip portions 98 when the first and second divided members 40, 50 are united while being displaced in the longitudinal direction of the linear wiring member 22.

It is assumed that the first and second lip portions 93, 98 are designed to be arranged at the same positions in the longitudinal direction of the linear wiring member 22. Even in this case, if the first and second divided members 40, 50 are united while being displaced in the longitudinal direction of the linear wiring member 22, the first and second lip portions 93, 98 are arranged at different positions in the longitudinal direction of the linear wiring member 22. However, the first and second reinforcing wall portions 92, 97 are kept in surface contact in an overlapping region in the longitudinal direction of the linear wiring member 22. Thus, when the linear wiring member arrangement hole 34 is entirely viewed in the circumferential direction, gaps are hardly formed between the first and second partially surrounding portions 43, 52.

Note that the first and second partially surrounding portions 63, 56 are also formed with lip portions and reinforcing wall portions similar to the above ones.

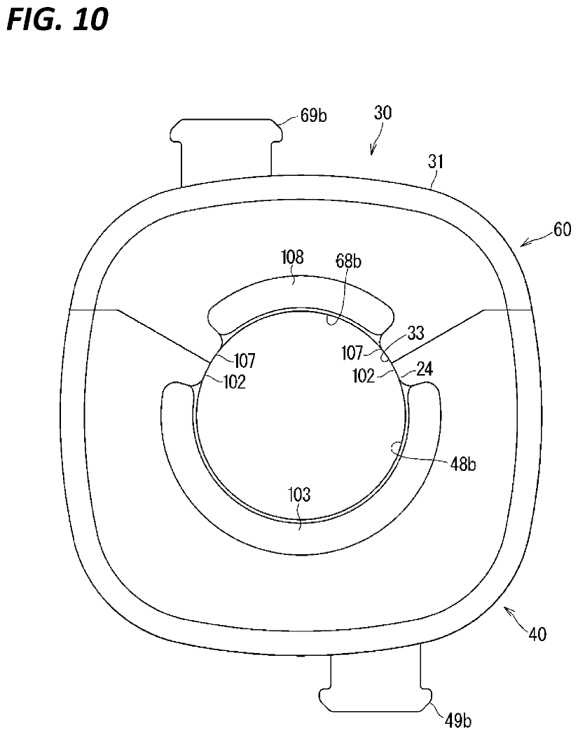

Further, in this embodiment, assuming the first divided member 40 as a first divided member and the third divided member 60 as a second divided member, the coating accommodation recess 48b on the side of the first divided member 40, out of the coating member arrangement hole 32, may be grasped as a first partially surrounding portion and the coating accommodation recess 68b on the side of the third divided member 60 may be grasped as a second partially surrounding portion 56 as shown in FIG. 10. Similarly to the above, the coating accommodation recess 48b serving as the first partially surrounding portion is formed with a pair of first reinforcing wall portions 102 and first lip portions 103 between the first reinforcing wall portions 102 and the coating accommodation recess 68b serving as the second partially surrounding portion is formed with a pair of second reinforcing wall portions 107 and second lip portions 108 between the second reinforcing wall portions 107.

Also in the coating member arrangement hole 32, the pair of first reinforcing wall portions 102, the first lip portions 103, the pair of second reinforcing wall portions 107 and the second lip portions 108 can be held in close contact with the end part of the coating member 24 entirely in the circumferential direction, similarly to the above.

An example of a manufacturing method of this wiring module 10 is described.

The wiring member 20 in which the linear wiring members 22 extend from the end part of the coating member 24 is prepared.

The positioning protrusion 77a of the first exterior member 72 is fit into the water-stop member side positioning recess 49a of the first divided member 40 and the water-stop member side positioning protrusion 49b of the first divided member 40 is fit into the positioning recess 77b of the first exterior member 72, whereby the first divided member 40 is set in the first exterior member 72.

Further, each linear wiring member 22 is pushed into the second partially surrounding portion 52, 56 of the second divided member 50. The second partially surrounding portion 52 is larger than the first partially surrounding portions 43, 63 and, here, formed to be larger than a semicircle. Further, the elongated openings of those are also formed to have a width smaller than the diameter of the linear wiring member 22. Thus, the linear wiring members 22 are less likely to come out from the second partially surrounding portions 52, 56.

In this state, the second divided member 50 is united with the first divided member 40 set in the first exterior member 72. In this way, the linear wiring members 22 are arranged in the linear wiring member arrangement holes 34 formed by the second partially surrounding portions 52 and the first partially surrounding portions 43.

Further, the third divided member 60 is united with the second divided member 50. In this way, the linear wiring members 22 are held in the linear wiring member arrangement holes 34 formed by the second partially surrounding portions 56 and the first partially surrounding portions 63.

The positioning protrusion 87a of the second exterior member 82 is fit into the water-stop member side positioning recess 69a of the third divided member 60 and the water-stop member side positioning protrusion 69b of the third divided member 60 is fit into the positioning recess 87b of the second exterior member 82, whereby the second exterior member 82 is put on the third divided member 60. Then, the uniting protrusions 74p are hooked and retained in the uniting recesses 84q. In this way, the first and second exterior members 72, 82 are kept in the united state. Then, the first, second and third divided members 40, 50 and 60 are compressed in a uniting direction between the water-stop member divided holding surfaces 75f and 85f, and the united state thereof is maintained.

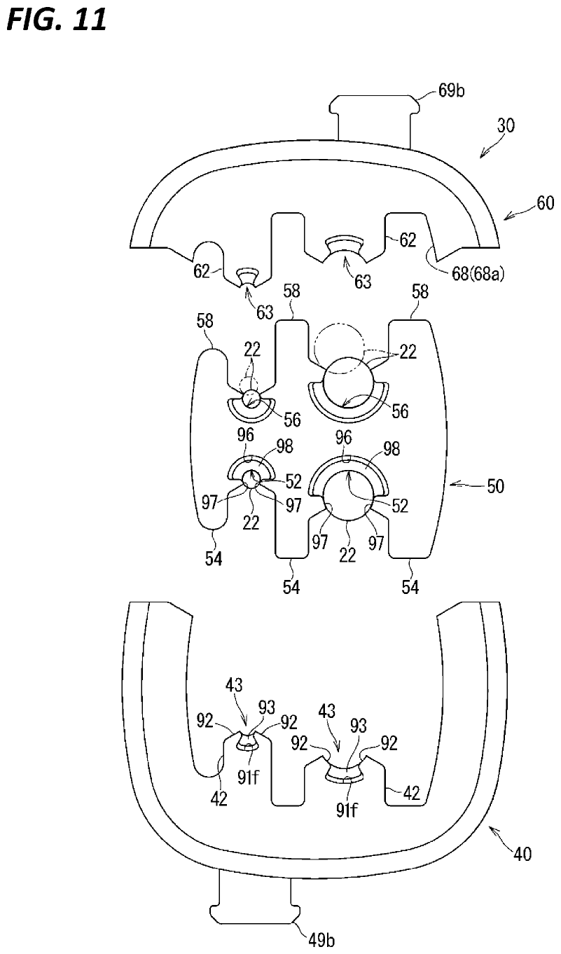

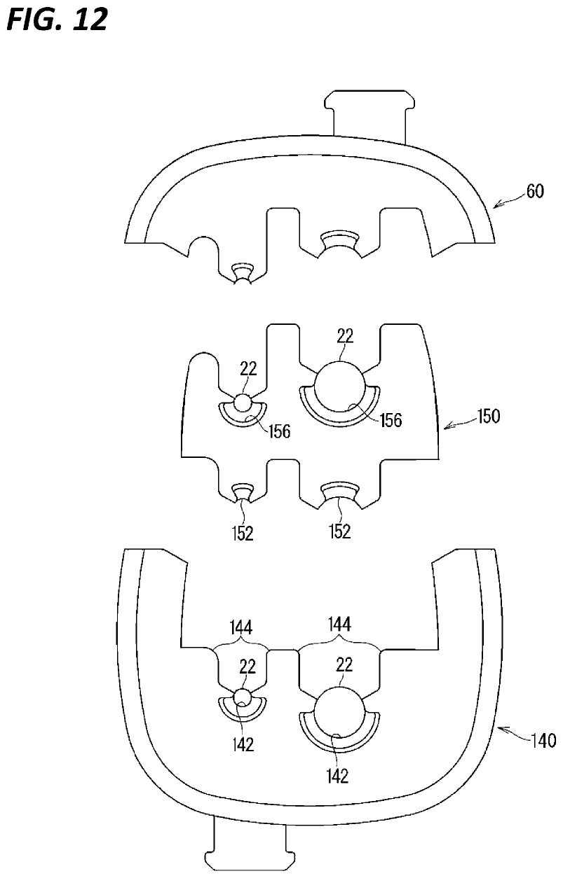

After the linear wiring members 22 are pushed into the second partially surrounding portions 52, 56, any one of the linear wiring members 22 may possibly remain to be arranged between the pair of guiding wall portions 54, 58 without completely entering the second partially surrounding portion 52, 56 like the linear wiring members 22 shown by two-dot chain lines in FIG. 11. Even in this case, if an attempt is made to unite the first and third divided members 40, 60 with the second divided member 50, the convex lid portion 42, 62 enters between the pair of guiding wall portions 54, 58 and pushes the linear wiring member 22 between the pair of guiding wall portions 54, 58 into the second partially surrounding portion 52, 56. Thus, the entire outer peripheries of the linear wiring members 22 are easily surrounded by the first partially surrounding portions 43, 63 and the second partially surrounding portions 52, 56.

Note that the above assembling order is an example and it is not necessarily essential that the assembly is performed in the above order.

According to the wiring module 10 and the elastic water-stop member 30 configured as just described, the first and second lip portions 93, 98 are pressed against the linear wiring members 22 by uniting the first and second divided members 40, 50. By this reaction force, the linear wiring members 22 are also pressed against the pairs of first reinforcing wall portions 92 and the pairs of the second reinforcing wall portions 97. Further, since the pairs of first reinforcing wall portions 92 and the pairs of second reinforcing wall portions 97 are butted against each other, deformation hardly occurs in these butted parts and gaps are hardly formed between the first and second divided members 40, 50. Thus, water stopping utilizing elasticity can be achieved around the linear wiring members 22 entirely in the circumferential direction, and more reliable water stopping can be achieved in boundary regions of the elastic water-stop member 30 when the elastic water-stop member 30 has a divided structure.

Further, since the pair of first reinforcing wall portions 92, the first lip portions 93, the pair of second reinforcing wall portions 97 and the second lip portions 98 are connected such that inner peripheral parts thereof form a circle, those are easily held in contact with the entire outer periphery of the linear wiring member 22.

Further, if the diameter of the above circle is set to be smaller than the diameter of the linear wiring member 22, the first and second lip portions 93, 98 are effectively compressed by being pushed radially outward. By this compressive force, the pair of first reinforcing wall portions 92 and the pair of first reinforcing wall portions 92 are pushed outward, thereby being pressed against each other. In this way, gaps between the first and second divided members 40, 50 are more reliably closed.

Further, the pair of first reinforcing wall portions 92 extend to connect the plurality of first lip portions 93, and the pair of second reinforcing wall portions 97 extend to connect the plurality of second lip portions 98. Thus, even if the first and second divided members 40, 50 are displaced and united, a close contact state between the pair of first reinforcing wall portions 92 and the pair of second reinforcing wall portions 97 is easily maintained, and water stopping property is easily maintained at boundaries between the first and second divided members 40, 50.

Further, if the pair of first reinforcing wall portions 92 and the pair of second reinforcing wall portions 97 have the same thickness, these can be held in contact in a well-balanced manner when being butted against each other and it is suppressed that the reinforcing wall portions are largely deformed toward either one side. In this way, a state where the first reinforcing wall portions 92 and the second reinforcing wall portions 97 are in contact with each other well in shapes close to initial shapes is easily maintained and gaps are hardly formed between those reinforcing wall portions.

Further, the elastic water-stop member 30 can stop water for the linear wiring members 22 by the first partially surrounding portions 63 and the second partially surrounding portions 56 also between the second divided member 50 and the third divided member 60 serving as the first divided member. Thus, the elastic water-stop member 30 is suitable for stopping water individually for each of the plurality of linear wiring members 22 included in the wiring member 20.

Further, the first partially surrounding portion 43, 63 and the second partially surrounding portion 52, 56 have different lengths in the circumferential direction of the linear wiring member arrangement hole 34. Thus, the first, second and third divided members 40, 50 and 60 can be easily united with the linear wiring members 22 stably arranged in the second partially surrounding portions 52, 56 having a longer length.

Further, the united state of the first, second and third divided members 40, 50 and 60 can be easily maintained by uniting the first and second exterior members 72, 82.

[Modifications]

Various modifications are described based on the above embodiment.

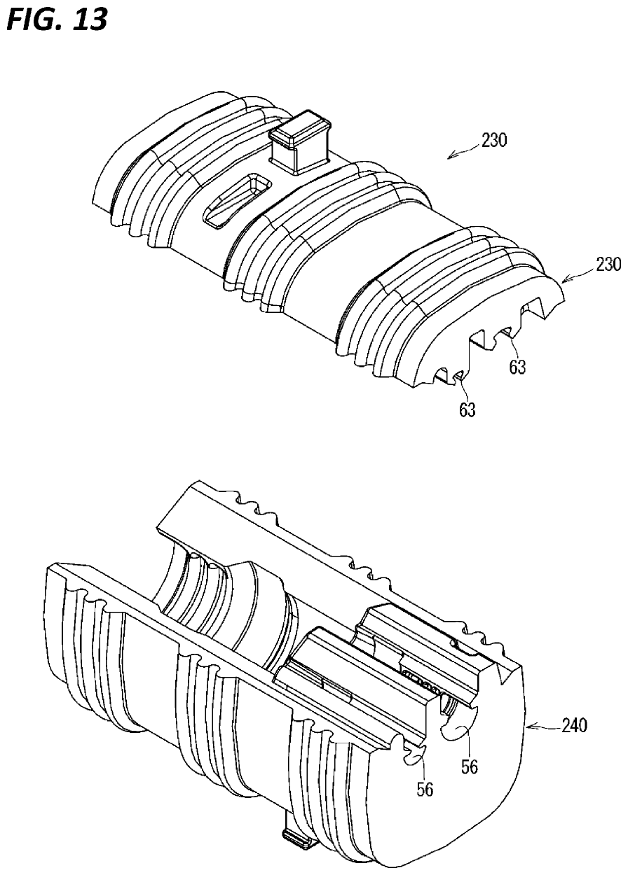

As shown in FIG. 12, in a relationship between a first divided member 140 corresponding to the first divided member 40 and a second divided member 150 corresponding to the second divided member 50, first partially surrounding portions 142 on the side of the first divided member 140 may be shaped deeper (having larger lengths in the circumferential direction of the linear wiring member arrangement hole 34) than second partially surrounding portions 152 on the side of the second divided member 150. In this case, the first divided member 140 may be formed with pairs of guiding wall portions 144.

The other configuration, particularly the configuration relating to facing parts of the second divided member 150 and the third divided member 60, is similar to the configuration described in the above embodiment.

According to this modification, the first and second divided members 140, 150 can be united with the linear wiring members 22 arranged in the first partially surrounding portions 142 of the first divided member 140. Then, the third divided member 60 can be united with the first and second divided members 140, 150 with the linear wiring members 22 arranged in second partially surrounding portions 56 of the second divided member 150.

Thus, in the configuration of assembling the second divided member 150 on the first divided member 140 and further assembling the third divided member 60 on the second divided member 150, the linear wiring members 22 are arranged with respect to the first divided member 140 and the linear wiring members 22 are arranged with respect to the second divided member 150 in accordance with that assembling order. Thus, an operation of successively assembling the respective components from above is easily performed in accordance with the assembling order of those.

Although the elastic water-stop member 30 is divided into three parts in the above embodiment, it is sufficient to divide an elastic water-stop member into a plurality of parts. For example, the elastic water-stop member may have a two-divided structure or may be divided into four or more parts.

FIG. 13 shows an example in which an elastic water-stop member 230 corresponding to the elastic water-stop member 30 has a two-divided structure. The elastic water-stop member 230 is provided with two divided members 240, 250. One divided member 240 is configured as if the first and second divided members 40, 50 in the above embodiment were integrally formed by a mold or the like. The divided member 240 may be grasped as a second divided member. The other divided member 250 is configured similarly to the third divided member 60. The divided member 250 may be grasped as a first divided member.

Also in this example, the divided member 240 is formed with second partially surrounding portions 56 and the divided member 250 is formed with first partially surrounding portions 63 as in the above embodiment. Thus, by uniting the divided members 240, 250, linear wiring members 22 can be arranged into linear wiring member arrangement holes 34 constituted by the second partially surrounding portions 56 and the first partially surrounding portions 63 while gaps at a boundary between the divided members 240, 250 are made as small as possible.

Note that the respective components described in the above embodiment and each modification can be appropriately combined without contradicting each other.

### LIST OF REFERENCE NUMERALS

10 wiring module
20 wiring member
22, 22a, 22b linear wiring member
24 coating member
24a end part
30, 230 elastic water-stop member
31 annular protrusion
32 coating member arrangement hole
34 linear wiring member arrangement hole
36 intermediate divided member accommodation hole
40, 140 first divided member
41a, 61a divided member erroneous assembly preventing protrusion
42, 62 convex lid portion
43, 63, 142 first partially surrounding portion
48, 68 accommodation recess
48a, 68a intermediate divided member accommodating portion
48b, 68b coating accommodation recess
49a, 69a water-stop member side positioning recess
49b, 69b water-stop member side positioning protrusion
50, 150 second divided member
51a divided member erroneous assembly preventing recess
52, 56, 152 second partially surrounding portion
54, 58, 144 guiding wall portion
60 third divided member
70 exterior member
72 first exterior member
73 bottom plate portion
74, 84 side wall portion
74p uniting protrusion
74q guide protrusion
75a, 85a first positioning portion
75b, 85b second positioning portion
75c restricting wall portion
75f, 85f water-stop member divided holding surface
76a, 86a semi-tubular holding portion
77a, 87a positioning protrusion
77b, 87b positioning recess
82 second exterior member
83 ceiling plate portion
84p uniting extending piece
84q uniting recess
91f, 96f circumferential surface
92, 102 first reinforcing wall portion
93, 103 first lip portion
97, 107 second reinforcing wall portion
98, 108 second lip portion
240, 250 divided member
500 lip portion

1. A wiring module, comprising:
a wiring member including at least one linear wiring member; and
an elastic water-stop member mounted on a part in a longitudinal direction of the wiring member,
the elastic water-stop member including a first divided member and a second divided member,
the first divided member being formed with a first partially surrounding portion constituting a part of a hole capable of accommodating the part in the longitudinal direction of the wiring member,
the second divided member being formed with a second partially surrounding portion constituting another part of the hole capable of accommodating the part in the longitudinal direction of the wiring member,
a pair of first reinforcing wall portions being formed on both sides in a circumferential direction of the first partially surrounding portion, a first lip portion being formed between the pair of first reinforcing wall portions,
a pair of second reinforcing wall portions being formed on both sides in a circumferential direction of the second partially surrounding portion, a second lip portion being formed between the pair of second reinforcing wall portions, and
the pair of first reinforcing wall portions and the pair of second reinforcing wall portions being butted against each other and at least a part of the wiring member being arranged in the hole constituted by the first and second partially surrounding portions with the first and second divided members united.

2. The wiring module of claim 1, wherein inner peripheral parts of the pair of first reinforcing wall portions, the first lip portion, the pair of second reinforcing wall portions and the second lip portion are connected to form a circle as a whole with the first and second divided members united.

3. The wiring module of claim 2, wherein a diameter of the circle formed by connecting the inner peripheral parts of the pair of first reinforcing wall portions, the first lip portion, the pair of second reinforcing wall portions and the second lip portions is smaller than a diameter of the part of the wiring member to be arranged in the hole.

4. The wiring module of claim 1, wherein:
a plurality of the first lip portions are formed side by side at intervals in the longitudinal direction of the wiring member,
the pair of first reinforcing wall portions extend to connect the plurality of first lip portions,
a plurality of the second lip portions are formed side by side at intervals in the longitudinal direction of the wiring member, and
the pair of second reinforcing wall portions extend to connect the plurality of second lip portions.

5. The wiring module of claim 1, wherein thicknesses of the pair of first reinforcing wall portions in a circumferential direction of the hole are equal to those of the pair of second reinforcing wall portions.

6. The wiring module of claim 1, wherein:
the wiring member includes a plurality of the linear wiring members,
the elastic water-stop member further includes a third divided member, and
one of the second and third divided members is formed with the first partially surrounding portion formed with the pair of first reinforcing wall portions and the first lip portion and the other of the second and third divided members is formed with the second partially surrounding portion formed with the pair of second reinforcing wall portions and the second lip portion in a part where the second and third divided members are facing each other.

7. The wiring module of claim 1, wherein a length of the first partially surrounding portion and that of the second partially surrounding portion in a circumferential direction of the hole are different.

8. The wiring module of claim 1, further comprising an exterior member including a first exterior member and a second exterior member unitable with each other,
wherein the elastic water-stop member is accommodated in the exterior member with the first and second exterior members united.

9. An elastic water-stop member to be mounted on a part in a longitudinal direction of a wiring member including at least one linear wiring member, comprising:
a first divided member; and
a second divided member,
the first divided member being formed with a first partially surrounding portion constituting a part of a hole capable of accommodating the part in the longitudinal direction of the wiring member,
the second divided member being formed with a second partially surrounding portion constituting another part of the hole capable of accommodating the part in the longitudinal direction of the wiring member,
a pair of first reinforcing wall portions being formed on both sides in a circumferential direction of the first partially surrounding portion, a first lip portion being formed between the pair of first reinforcing wall portions,
a pair of second reinforcing wall portions being formed on both sides in a circumferential direction of the second partially surrounding portion, a second lip portion being formed between the pair of second reinforcing wall portions, and
the pair of first reinforcing wall portions and the pair of second reinforcing wall portions being butted against each other and the hole capable of arranging at least a part of the wiring member therein being formed by the first and second partially surrounding portions with the first and second divided members united.
